(19) United States
(12) Patent Application Publication
(10) Pub. No.: US 2019/0057642 A1
(43) Pub. Date: Feb. 21, 2019

(54) ELECTRONIC DEVICE AND DISPLAY FOR REDUCING LEAKAGE CURRENT

(71) Applicant: Samsung Electronics Co., Ltd., Gyeonggi-do (KR)

(72) Inventors: Young Do KIM, Gyeonggi-do (KR); Hyun Chang Shin, Gyeonggi-do (KR); Song Hee Jung, Gyeonggi-do (KR)

(21) Appl. No.: 16/104,278

(22) Filed: Aug. 17, 2018

(30) Foreign Application Priority Data
Aug. 17, 2017 (KR) 10-2017-0103937

(51) Int. Cl. G09G 3/32; G06K 9/00; G06K 9/20

(52) U.S. Cl. CPC G09G 3/32; G06K 9/0004; G06K 9/00604; G09G 2310/08; G09G 2320/0247; G09G 2320/0233; G06K 9/2027

(57) ABSTRACT

An electronic device is provided. The electronic device includes a display panel including a plurality of pixels, a light source positioned around the plurality of pixels, a display driver integrated circuit including a driver configured to control whether the pixels emit light and a timing controller configured to control an on/off operation of the driver, a sensor electrically connected with the light source and the display driver integrated circuit, and configured to sense an external object by using light of a specified wavelength band emitted from the light source, and a processor electrically connected with the display driver integrated circuit and the sensor. The processor is configured to receive a time indicating when the timing controller turns off the driver from the display driver integrated circuit and allow the light source to emit the light of the specified wavelength band based at least on the received time.

### CROSS-REFERENCE TO RELATED APPLICATION(S)

This application is based on and claims priority under 35 U.S.C. § 119 to Korean Patent Application Serial No. 10-2017-0103937, filed on Aug. 17, 2017, in the Korean Intellectual Property Office, the entire disclosure of which is incorporated herein by reference.

### BACKGROUND

### 1. Field

The disclosure relates, generally, to an electronic device, and more particularly, to an electronic device for reducing a leakage current flowing to a display.

### 2. Description of the Related Art

An electronic device equipped with a display, such as a smailphone, a wearable device, or the like has been widely supplied as mobile communication technologies develop. The electronic device may execute various functions such as a photo or video capturing function, a music or video file play function, a game function, an Internet function, and the like through the display.

However, when the size of the display is small, it may be inconvenient to execute the above functions. For example, with a small-sized display, since icons are small, a plurality of icons may be simultaneously selected against the intention of a user. An application which is not intended by the user may be executed, or a user input may be ignored. As such, technology associated with a full front display and for maximally expanding the size of the display are developing.

As an area of a front surface of the electronic device that is occupied by the display increases in size, various parts which were positioned on the front surface of the electronic device are being positioned within the electronic device. For example, an infrared light source which was used for a proximity sensor or an illumination sensor is being positioned within the electronic device (e.g., below the display).

However, infrared light output from the light source may cause a photoelectric effect at a transistor included in the display. This may mean that a leakage current is generated. The leakage current may allow different areas of the display to emit light with different brightness or may cause a flicker phenomenon (e.g., a phenomenon in which a partial area of the display flickers). The flicker phenomenon or the like may have a significant influence on the user's eyesight or may make the user feel tired.

### SUMMARY

The present disclosure has been made to address at least the disadvantages described above and to provide at least the advantages described below.

In accordance with an aspect of the disclosure, there is provided an electronic device. The electronic device includes a display panel including a plurality of pixels, a light source positioned around at least a part of the plurality of pixels, a display driver integrated circuit including a driver configured to control whether the pixels emit light and a timing controller configured to control an on/off operation of the driver, a sensor electrically connected with the light source and the display driver integrated circuit, and configured to sense an external object by using light of a specified wavelength band emitted from the light source, and a processor electrically connected with the display driver integrated circuit and the sensor. The processor is configured to receive a time indicating when the timing controller turns off the driver from the display driver integrated circuit and allow the light source to emit the light of the specified wavelength band based at least on the received time.

In accordance with an aspect of the disclosure, there is provided an electronic device. The electronic device includes a housing including a first surface, a second surface facing away from the first surface, and a side surface surrounding a space between the first surface and the second surface, a display panel including a plurality of pixels where at least a portion of the display panel is exposed through the first surface, a sensor positioned around at least a part of the plurality of pixels and including a light source configured to emit light of a specified wavelength band, and a display driver integrated circuit electrically connected with the sensor and including a driver configured to control whether the pixels emit light, and a timing controller configured to control an on/off operation of the driver. The sensor turns the light source on or off to sense an external object, and the display driver integrated circuit allows the sensor to turn on the light source while the timing controller turns off the driver.

In accordance with an aspect of the disclosure, there is provided a display. The display includes an infrared light-emitting unit configured to emit light of an infrared band, a display panel including one or more pixels each including at least one light-emitting unit, and a display driver integrated circuit. Each of the one or more pixels includes one or more switches connected between the at least one light-emitting unit and a power input terminal, and the display driver integrated circuit is configured to close the one or more switches to allow the power input terminal to apply a power to the at least one light-emitting unit during a first time when the light in the infrared band is not output through the infrared light-emitting unit, and open switches of the one or more switches that are included in at least a part of the one or more pixels during a second time when the light in the infrared band is output by using the infrared light-emitting unit.

### BRIEF DESCRIPTION OF THE DRAWINGS

The above and other aspects, features and advantages of certain embodiments of the disclosure will be more apparent from the following detailed description taken in conjunction with the accompanying drawings, in which:

FIG. 1 is a diagram of an electronic device, according to an embodiment;

FIG. 2 is a diagram of a display and a processor, according to an embodiment;

FIG. 3 is a diagram of a sub-pixel, according to an embodiment;

FIG. 4 is a diagram of an operation of a display driver integrated circuit, according to an embodiment;

FIG. 5 is a diagram of an operation of a display driver integrated circuit, according to an embodiment;

FIG. 6 is a diagram of an operation of a display driver integrated circuit, according to an embodiment;

FIG. 7 is a diagram of an operation of a display driver integrated circuit, according to an embodiment;

FIG. 8 is a diagram of a sub-pixel, according to an embodiment;

FIG. 9 is a diagram of an electronic device, which includes a display for reducing the leakage current, in a network environment, according to an embodiment; and

FIG. 10 is a diagram of a display device for reducing a leakage current, according to an embodiment.

### DETAILED DESCRIPTION

Embodiments of the disclosure will be described herein below with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device indicates different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

The terms used in describing the various embodiments of the disclosure are for the purpose of describing particular embodiments and are not intended to limit the disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. Terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the disclosure.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the disclosure may include at least one of an application-specific integrated circuit (ASIC) chip, a field-programmable gate array (FPGA), and a programmable-logic device for performing operations which has been known or are to be developed hereinafter.

An electronic device according to the disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. The wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

The electronic device may be a home appliance. The home appliance may include at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

The electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), avionics, security devices, an automotive head unit, a robot for home or industry, an automatic teller machine (ATM) in banks, point of sales (POS) devices in a shop, or an Internet of things (IoT) device (e.g., a light bulb, various sensors, electric or gas meter, a sprinkler device, a fire alarm, a thermostat, a streetlamp, a toaster, a sporting goods, a hot water tank, a heater, a boiler, etc.).

The electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may also be a flexible device. Further, the electronic device is not limited to the aforementioned devices, and may include an electronic device according to the development of new technology.

Hereinafter, an electronic device will be described with reference to the accompanying drawings. In the disclosure, the term “user” indicates a person using an electronic device or a device (e.g., an artificial intelligence electronic device) using an electronic device.

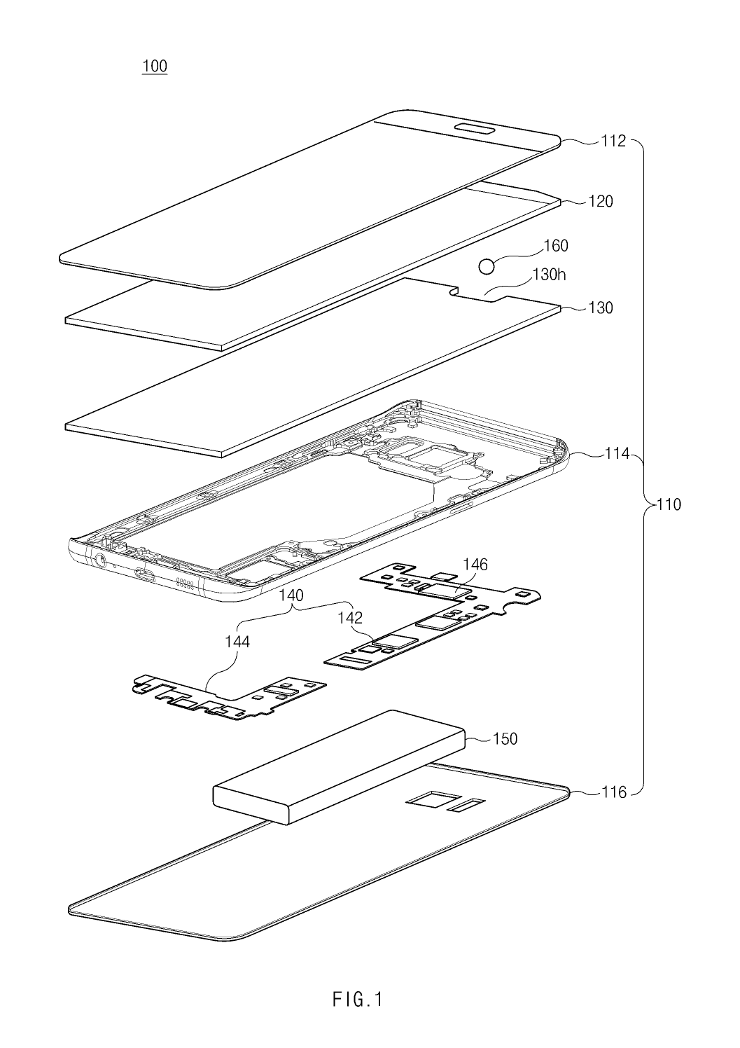

FIG. 1 is a diagram of an electronic device, according to an embodiment.

Referring to FIG. 1, an electronic device 100 may include a housing 110, a display 120, a shield sheet 130, a printed circuit board (PCB) 140, a battery 150, and a light source 160. The electronic device 100 may be implemented without some of the components illustrated in FIG. 1 or may be implemented to further include one or more components not illustrated in FIG. 1. Also, the order in which the components included in the electronic device 100 are stacked may be different from the stacked order illustrated in FIG. 1.

The housing 110 may include a first surface, a second surface, and a side surface surrounding a space between the first surface and the second surface. The first surface, the second surface, and the side surface may be respectively referred to as a cover glass 112, a rear cover 116, and a side housing 114.

The cover glass 112 may transmit light generated by the display 120. Also, a user may touch a portion (e.g., a finger) of his/her body on the cover glass 112 to perform a touch (including a contact using an electronic pen). The cover glass 112 may be formed of tempered glass, reinforced plastics, a flexible polymer material, or the like. The cover glass 112 may be also referred to as a glass window.

The side housing 114 may protect the components included in the electronic device 100. The display 120, the PCB 140, the battery 150, and the like may be accommodated within the side housing 114, and the side housing 114 may protect the components from an external shock.

The side housing 114 may include an area which is not exposed to the outside of the electronic device 100 and an area which is exposed through the outside of the electronic device 100. The area which is not exposed to the outside of the electronic device 100 may be formed of a non-conductive material. The area which is exposed to the outside of the electronic device 100 may be formed of metal. The exposed area, which is formed of a metal material, may be also referred to as a metal bezel. At least a portion of the metal bezel may be used as an antenna element for transmitting or receiving a signal in a specified frequency band.

The rear cover 116 may be coupled to a rear surface of the electronic device 100 (i.e., positioned under the side housing 114). The rear cover 116 may be formed of tempered glass, plastic, and/or metal. The rear cover 116 may be integrally implemented with the side housing 114 or may be implemented to be removable by the user.

The display 120 may be interposed under the cover glass 112. The display 120 may be electrically connected with the PCB 140, and may output content (e.g., a text, an image, a video, an icon, a widget, a symbol, or the like) or may receive a touch input (e.g., a touch, a gesture, a hovering, or the like) from the user.

The shield sheet 130 may be interposed between the display 120 and the side housing 114. The shield sheet 130 may shield an electro-magnetic wave generated between the display 120 and the PCB 140 to prevent an electro-magnetic interference between the display 120 and the PCB 140.

The shield sheet 130 may include a thin film sheet or a plate which is formed of copper (Cu) or graphite. When the shield sheet 130 is formed of copper or graphite, components included in the electronic device 100 may be grounded to the shield sheet 130.

Various electronic parts, elements, a printed circuit, or the like of the electronic device 100 may be mounted on the PCB 140. An AP 146, a communication processor (CP), a memory, or the like may be mounted on the PCB 140. The PCB 140 may be referred to as a main board or printed board assembly (PBA).

The PCB 140 may include a first PCB 142 and a second PCB 144. The first PCB 142 may be referred to as a “main PCB” on which the AP 146 is mounted. The second PCB 144 may be referred to as a sub-PCB connected with the main PCB.

The battery 150 may convert chemical energy and electrical energy bi-directionally. The battery 150 may convert chemical energy into electrical energy and may supply the electrical energy to the display 120 and various components or modules mounted on the PCB 140. Alternatively, the battery 150 may convert and store electrical energy from the outside into chemical energy. A power management module for managing charging and discharging of the battery 150 may be included in the PCB 140.

The light source 160 may emit light of a specific wavelength (e.g., infrared light). The light source 160 may refer to an element which is included in a sensor (e.g., a fingerprint sensor, a proximity sensor, an iris sensor, or the like) and emits the infrared light. The electronic device 100 may sense a distance between the electronic device 100 and the user by using the light emitted from the light source 160. When the sensed distance is less than a specified length, the electronic device 100 may turn off the display 120. When the sensed distance is greater than or equal to the specified length, the electronic device 100 may turn on display 120.

The electronic device 100 may measure biometric information by using the light emitted from the light source 160. The electronic device 100 may obtain fingerprint information of a finger which is in contact with the cover glass 112. The electronic device 100 may sense the light which is reflected from the finger after being emitted from the light source 160 and may obtain the fingerprint information based on the sensed light. The electronic device 100 may measure iris information of the user by using the light emitted from the light source 160. The electronic device 100 may sense the light which is reflected from the iris after being emitted from the light source 160 and may obtain the iris information based on the sensed light.

The biometric information may include the fingerprint information, the iris information, a blood flow rate, oxygen saturation, or the like. The electronic device 100 may differently use a light source depending on a kind of biometric information to be measured.

TABLE 1

| Combination of light sources | Biometric information |
|---|---|
| Green LED | Heart rate |
| Infrared LED | Heart rate, stress level |
| Infrared LED and red LED | Blood oxygen saturation |
| Infrared LED, blue LED, and green LED | Blood sugar, blood pressure |
| Infrared LED, red LED, blue LED, and | Skin tone, moisture level |
| green LED | |

Referring to Table 1, the electronic device 100 may measure a heart rate of the user by using the green LED. The electronic device 100 may measure the heart rate of the user based on the light emitted from the green LED. The electronic device 100 may measure blood oxygen saturation by using the infrared LED and the red LED.

The light source 160 may be positioned around pixels arranged in a display panel 121. The light source 160 may be positioned between the pixels or may be positioned at an edge of an active area.

An opening 130h may be defined in a partial area of the shield sheet 130. When viewed from above the cover glass 112, the opening 130h may at least partially overlap the active area of the display 120. The opening 130h may be positioned in an area corresponding to the opening 130h. The light source 160 may be interposed between the display 120 and the shield sheet 130, or may be interposed between the shield sheet 130 and the side housing 114. When the light source 160 is interposed between the shield sheet 130 and the side housing 114, the light emitted from the light source 160 may be output to the outside of the electronic device 100 through the opening 130h and the cover glass 112.

The light source 160 is illustrated in FIG. 1 as being interposed between the display 120 and the shield sheet 130, but the light source 160 may be interposed between the display 120 and the cover glass 112. A position of the light source 160 is not limited to the position illustrated in FIG. 1, as the light source 160 may be positioned in any area within the housing 110.

The electronic device 100 may make the light source 160 emit light in a state where the display 120 is turned off. The state where the display 120 is turned off may be a state where a pixel included in the display 120 does not emit light or a state where an emission driver included in the display 120 is turned off.

The electronic device 100 may make the light source 160 emit light in the case where an area, which is adjacent to a position where the light source 160 is positioned, of the display 120 is off. The remaining area of the display 120 may be on and may output an image, a video, or the like.

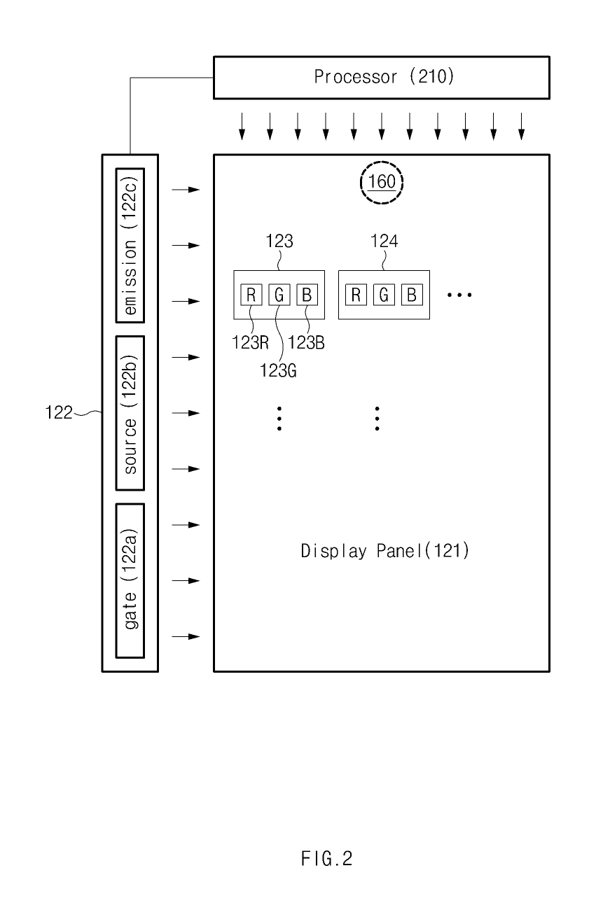

FIG. 2 is a diagram of a display and a processor, according to an embodiment.

Referring to FIG. 2, the display 120 may include the display panel 121 and a display driver integrated circuit 122.

The display panel 121 may include a plurality of pixels 123 and 124. The plurality of pixels 123 and 124 may be arranged on the display panel 121 at given intervals.

Each of the plurality of pixels 123 and 124 may include a plurality of sub-pixels 123R, 123G, and 123B. One pixel 123 may include a red sub-pixel 123R, a green sub-pixel 123G, and a blue sub-pixel 123B. Each of the sub-pixels 123R, 123G, and 123B may include a plurality of transistors or switches, at least one capacitive element (e.g., a capacitor), and a light-emitting element (e.g., an organic LED (OLED) or a light-emitting unit). One pixel 123 may include the red sub-pixel 123R, the green sub-pixel 123G, the blue sub-pixel 123B, and the green sub-pixel 123G.

The display driver integrated circuit 122 may be connected with the sub-pixels 123R, 123G, and 123B and may allow the light-emitting element to emit light. The display driver integrated circuit 122 may include a gate driver 122a, a source driver 122b (or a data driver), and an emission driver 122c. The gate driver 122a may control on/off operations of transistors included in the sub-pixels 123R, 123G, and 123B. The source driver 122b may apply a data voltage to the capacitor through the transistors. The emission driver 122c may adjust a timing when the light-emitting element is turned on, by controlling the on/off operations of the transistors.

The display driver integrated circuit 122 may turn on the light source 160 while the emission driver 122c is in an off state. The display driver integrated circuit 122 may transmit a first signal for turning off the emission driver 122c to the emission driver 122c. The display driver integrated circuit 122 may extract a timing or a time indicating when the first signal is transmitted and may transmit a second signal for turning on the light source 160 while the first signal is transmitted, to the light source 160. Through the above-described process, the display driver integrated circuit 122 may turn on the light source 160 while the emission driver 122c is in the off state.

When the emission driver 122c is in the off state, the transistors included in the sub-pixels 123R, 123G, and 123B may also be in the off state. Accordingly, even though the light source 160 is turned on, a leakage current may not flow in the transistors. Light may be prevented from being abnormally emitted from a pixel or a sub-pixel by preventing a leakage current from flowing in the transistors. Also, by preventing a leakage current from flowing in the transistors, the quality of image may be improved, and a flicker phenomenon may be prevented.

A processor 210 may turn on the light source 160 while the emission driver 122c is in the off state. The processor 210 may be electrically connected with the light source 160 and the display driver integrated circuit 122. The processor 210 may receive the timing or the time indicating when the first signal for turning on the emission driver 122c is transmitted, from the display driver integrated circuit 122. The processor 210 may transmit a third signal for turning on the light source 160 while the first signal is transmitted, to the light source 160. Through the above-described process, the processor 210 may turn on the light source 160 while the emission driver 122c is in the off state. A sensor hub or a micro control unit (MCU) may turn on the light source 160 while the emission driver 122c is in the off state.

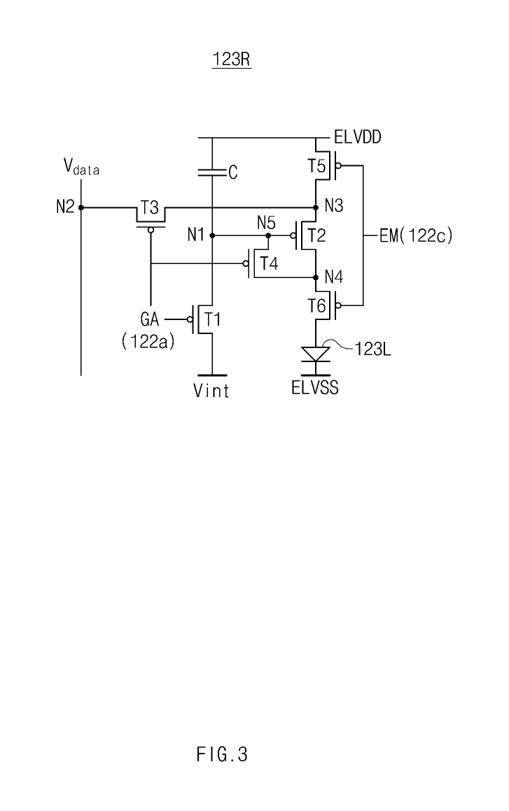

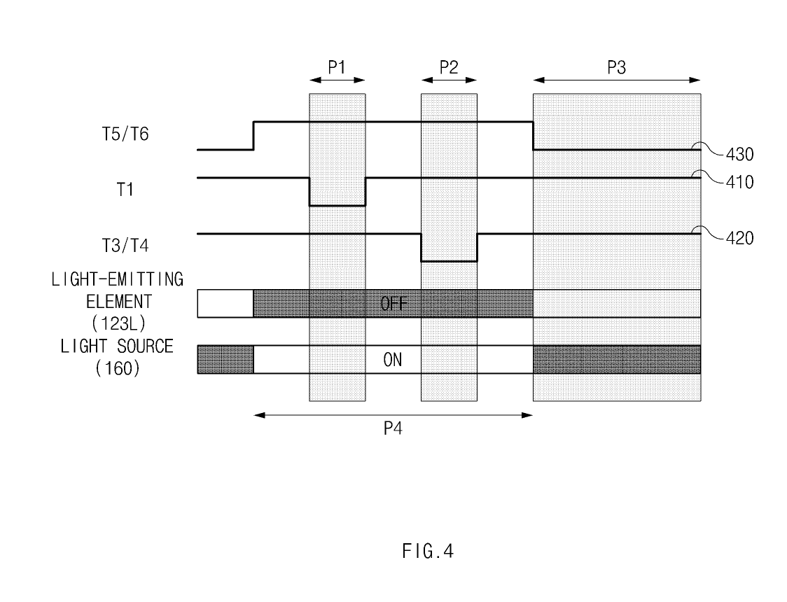

FIG. 3 is a diagram of a sub-pixel, according to an embodiment. FIG. 4 is a diagram of an operation of a display driver integrated circuit, according to an embodiment. FIG. 4 shows an operation timing of the display driver integrated circuit 122 for allowing the sub-pixel 123R illustrated in FIG. 3 to emit light.

Referring to FIGS. 3 and 4, graph 410 indicates a gate signal which the gate driver 122a transmits to a first transistor T1, graph 420 indicates a gate signal which the gate driver 122a transmits to a third transistor T3 and a fourth transistor T4, and graph 430 indicates an emission signal which the emission driver 122c transmits to a fifth transistor T5 and a sixth transistor T6.

The gate driver 122a may transmit a gate signal to a gate terminal of the first transistor T1 during a first time P1. As the gate signal is transmitted, the first transistor T1 may be turned on during the first time P1. When the first transistor T1 is turned on, an initialization voltage Vint may be applied to a first node N1 and a gate terminal of a second transistor T2. The initialization voltage Vint may be used to initialize a voltage applied to the gate terminal of the second transistor T2.

The gate driver 122a may transmit a gate signal to gate terminals of the third transistor T3 and the fourth transistor T4 during a second time P2. As the gate signal is transmitted, the third transistor T3 and the fourth transistor T4 may be turned on. When the third transistor T3 is turned on, a second node N2 and a third node N3 may be substantially the same node. Accordingly, a first voltage (e.g., a data voltage Vdata) may be applied to the third node N3 through the third transistor T3.

Meanwhile, when the fourth transistor T4 is turned on, a fourth node N4 and a fifth node N5 may be substantially the same node. Accordingly, a second voltage may be applied to the fifth node N5 and the first node N1 through the fourth transistor T4. Here, the second voltage may mean a sum of the first voltage and a threshold voltage of the second transistor T2. Through the above-described process, the second voltage may be applied to one end of a capacitive element “C”, and a third voltage (e.g., ELVDD) may be applied to an opposite end of the capacitive element “C”. The second voltage and the third voltage may charge the capacitive element “C”.

The charged capacitive element “C” may apply a voltage, which is greater than or equal to a threshold voltage, to the gate terminal of the second transistor T2 during a third time P3. As such, the second transistor T2 may be turned on during the third time P3. Meanwhile, the display driver integrated circuit 122 (or a timing controller) may turn on the emission driver 122c during the third time P3. The emission driver 122c may transmit the emission signal to gate terminals of the fifth transistor T5 and the sixth transistor T6 during the third time P3. As such, the fifth transistor T5 and the sixth transistor T6 may be turned on.

When the second transistor T2, the fifth transistor T5, and the sixth transistor T6 are turned on, a current may flow through the second transistor T2, the fifth transistor T5, and the sixth transistor T6. The current may allow a light-emitting element 123L to emit light.

The display driver integrated circuit 122 may allow the light source 160 to emit light during a specified time P4. The specified time P4 may mean a time when an off state of the emission driver 122c is maintained. The display driver integrated circuit 122 may allow the light source 160 to emit light during the first time P1 and/or during the second time P2. A leakage current of the transistors T1 to T6 may be reduced by turning on the light source 160 while the emission driver 122c is in the off state.

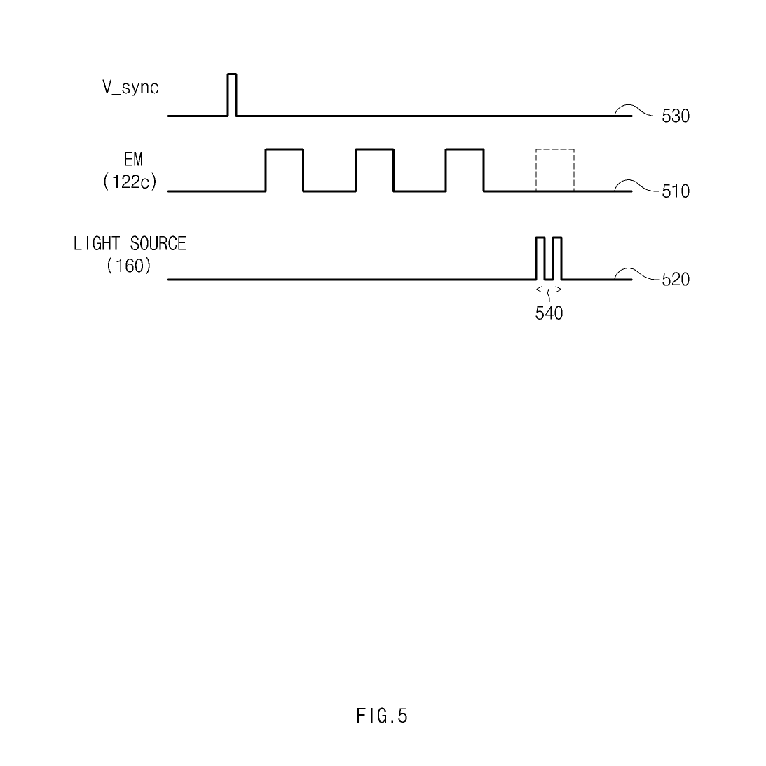

FIG. 5 is a diagram of an operation of a display driver integrated circuit, according to an embodiment.

Referring to FIG. 5, graph 510 indicates whether the emission driver 122c is turned on or off, and graph 520 indicates whether the light source 160 is turned on or off. In graph 510 and graph 520, a high state may be a state when the emission driver 122c and the light source 160 are turned on. In contrast, a low state may be a state when the emission driver 122c and the light source 160 are turned off.

Referring to graph 510, the display driver integrated circuit 122 (or a timing controller) may turn on or off the emission driver 122c. The display driver integrated circuit 122 may turn on the emission driver 122c during a given time and may turn off the emission driver 122c during a given time. An operation of turning on the emission driver 122c and an operation of turning off the emission driver 122c may be consistently iterated.

The display driver integrated circuit 122 may turn on the emission driver 122c and the light source 160 at different times by adjusting a duty cycle. The duty cycle may mean a ratio of an on time of a period where the emission driver 122c is turned on and off. Assuming that the display driver integrated circuit 122 turns on and off the emission driver 122c at a period of 1 ms, in the case where the on time is 0.5 ms, the duty cycle may be 0.5.

In FIG. 5, the display driver integrated circuit 122 may adjust the duty cycle in a period 540 where the light source 160 is turned on. The display driver integrated circuit 122 may adjust (or set) the duty cycle to “0” in the period 540 where the light source 160 is turned on. Since the duty cycle is “0”, the emission driver 122c may be in an off state in the period 540 where the light source 160 is turned on.

The display driver integrated circuit 122 may transmit a synchronization signal 530 to the AP 146. The synchronization signal 530 indicates a timing/time when the display driver integrated circuit 122 turns off the emission driver 122c. The AP 146 may detect the timing/time when the emission driver 122c is turned off, by receiving the synchronization signal 530 from the display driver integrated circuit 122. When the emission driver 122c is turned off, the AP 146 may allow the light source 160 to emit light.

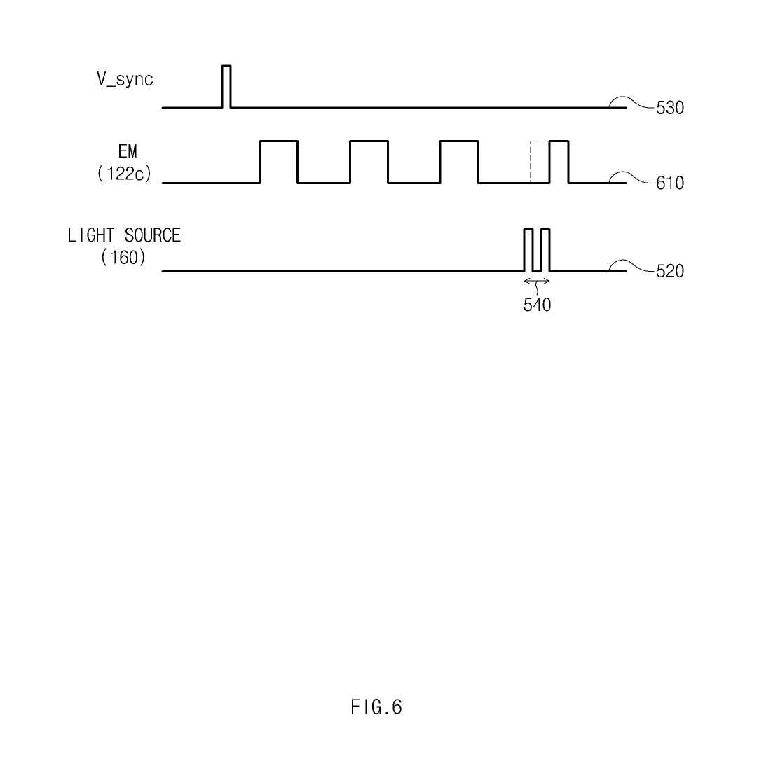

FIG. 6 is a diagram of an operation of a display driver integrated circuit, according to an embodiment.

Referring to FIG. 6, the display driver integrated circuit 122 may turn on the emission driver 122c and the light source 160 at different timings/times by adjusting an on time. The on time may refer to a time when the emission driver 122c is turned on within one period. Graph 610 indicates a signal which the display driver integrated circuit 122 uses to adjust the on time of the emission driver 122c. Assuming that the display driver integrated circuit 122 turns on the emission driver 122c during 0.5 ms and turns off the emission driver 122c during 0.5 ms, the period may be 1 ms, and the on time may be 0.5 MS.

In FIG. 6, the display driver integrated circuit 122 may adjust the on time in the period 540 where the light source 160 is turned on. When the period 540 where the light source 160 is turned on overlaps the on time (e.g., 0.3 ms overlapping), the display driver integrated circuit 122 may reduce the on time from 0.5 ms to 0.2 ms. As such, the display driver integrated circuit 122 may turn on the emission driver 122c and the light source 160 at different timings/times by adjusting the on time.

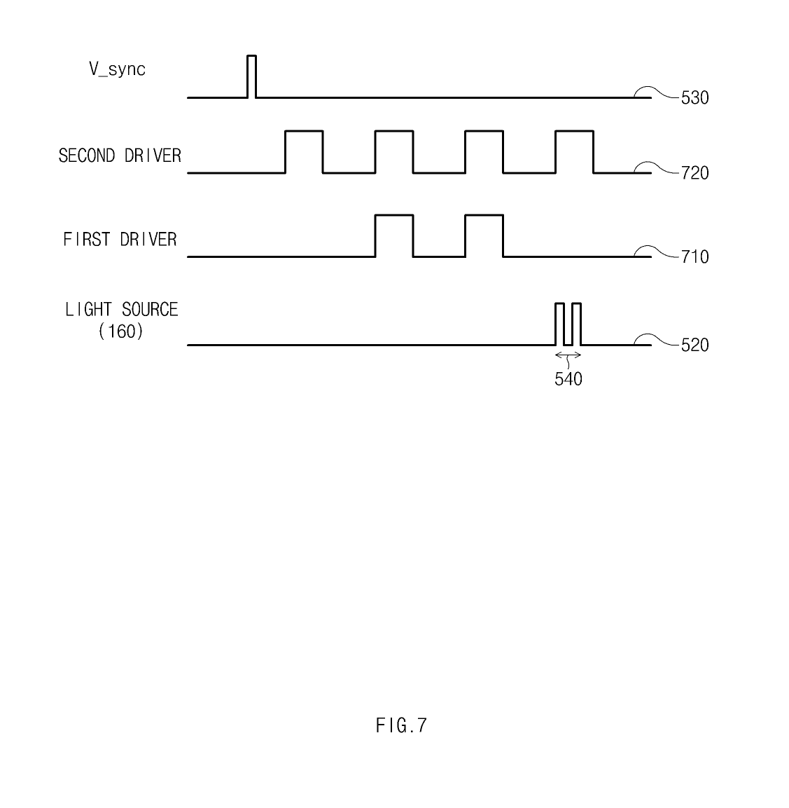

FIG. 7 is a diagram of an operation of a display driver integrated circuit, according to an embodiment.

Referring to FIG. 7, the emission driver 122c may be divided into a plurality of drivers. The emission driver 122c may be divided into a first driver (e.g., a first pixel group driver) and a second driver (e.g., a second pixel group driver). The first driver may be a driver connected with pixels adjacent to a position where the light source 160 is positioned. The second driver may be a driver connected with the remaining pixels. Graph 710 indicates whether the first driver is turned on or off, and graph 720 indicates whether the second driver is turned on or off.

Referring to graph 710 and graph 720, the display driver integrated circuit 122 may turn on and off the second driver at a specified period. However, the display driver integrated circuit 122 may turn off the first driver during the period where the light source 160 is turned on. The display driver integrated circuit 122 may turn on the first driver and the light source 160 at different timings by adjusting the duty and/or the on time of the first driver.

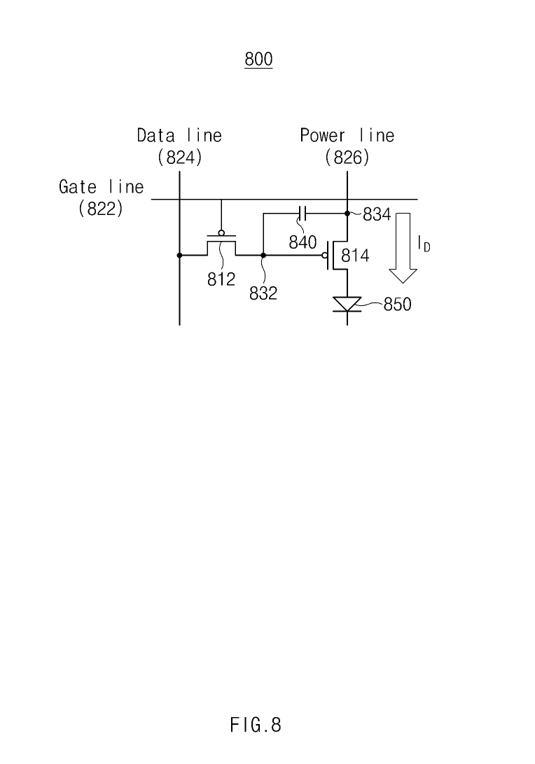

FIG. 8 is a diagram of a sub-pixel, according to an embodiment.

Referring to FIG. 8, a sub-pixel 800 may include a first transistor 812, a second transistor 814, a capacitive element 840, and a light-emitting element 850.

The gate driver 122a may transmit a gate signal to a gate terminal of the first transistor 812 through a gate line 822. As the gate signal is transmitted, the first transistor 812 may be turned on. A first voltage (e.g., a data voltage) applied to a data line 824 may be applied to a first node 832 through the first transistor 812.

A second voltage applied to a power line 826 may be applied to a second node 834. As such, the first voltage may be applied to one end of the capacitive element 840, and the second voltage may be applied to an opposite end of the capacitive element 840. The first voltage and the second voltage may charge the capacitive element 840.

The one end of the capacitive element 840 may be connected with a gate terminal of the second transistor 814, and the opposite end of the capacitive element 840 may be connected with a source terminal of the second transistor 814. Accordingly, the charged capacitive element 840 may apply a given voltage to the gate terminal and the source terminal of the second transistor 814.

When the voltage applied through the capacitive element 840 is greater than a threshold voltage of the second transistor 814, the second transistor 814 may be turned on. When the second transistor 814 is turned on, a current may flow through the second transistor 814, and the current may allow the light-emitting element to emit light.

According to an embodiment, an electronic device may include a display panel that includes a plurality of pixels, a light source that is positioned around at least a part of the plurality of pixels, a display driver integrated circuit that includes a driver to control whether the pixels emit light and a timing controller to control an on/off operation of the driver, a sensor that is electrically connected with the light source and the display driver integrated circuit and senses an external object by using light of a specified wavelength band emitted from the light source, and a processor that is electrically connected with the display driver integrated circuit and the sensor. The processor may receive a time indicating when the timing controller turns off the driver, from the display driver integrated circuit, and may allow the light source to emit the light of the specified wavelength band, based at least on the received time.

The processor may allow the light source to emit the light of the specified wavelength band during at least partial period where the timing controller turns off the driver.

The processor may allow the timing controller to turn on the driver during a first time, and may allow the light source to emit the light of the specified wavelength band during a second time at least partially different from the first time.

The processor may allow the timing controller to turn on/off the driver at a specified period.

The electronic device may further include a shield sheet that is positioned under the display panel, an opening may be defined in a specified area of the shield sheet, and the light source may be positioned in an area corresponding to the opening.

The pixels a first pixel group positioned in an area around the light source, and a second pixel group corresponding to pixels not included the first pixel group, and the driver may include a first pixel group driver electrically connected with the first pixel group, and a second pixel group driver electrically connected with the second pixel group.

The processor may receive a time indicating when the timing controller turns off the first driver, and may allow the light source to emit the light of the specified wavelength band based at least on the received time to turn off the first driver.

The driver may include an emission driver, and the driver may control whether the pixels emit light, by controlling an on/off operation of a transistor included in each of the pixels.

The sensor may obtain biometric information including fingerprint information of a finger of a user or iris information of the user, by using the light of the specified wavelength band.

The processor may allow the display driver integrated circuit to turn on at least a part of the pixels when a distance from the sensed external object is greater than or equal a specified length, and may allow the display driver integrated circuit to turn off the at least a part of the pixels when the distance from the sensed external object is less than the specified length.

The processor may allow the light source to emit light in an infrared band.

According to an embodiment, an electronic device may include a housing that includes a first surface, a second surface facing away from the first surface, and a side surface surrounding a space between the first surface and the second surface, a display panel that includes a plurality of pixels, at least a portion of the display panel being exposed through the first surface, a sensor that is positioned around at least a part of the plurality of pixels and includes a light source to emit light of a specified wavelength band, a display driver integrated circuit that is electrically connected with the sensor and includes a driver to control whether the pixels emit light and a timing controller to control an on/off operation of the driver. The sensor may turn the light source on or off to sense an external object, and the display driver integrated circuit may allow the sensor to turn on the light source while the timing controller turns off the driver.

The electronic device may further include a printed circuit board that is interposed between the display panel and the second surface, and a processor that is mounted on the printed circuit board and is electrically connected with the sensor and the display driver integrated circuit.

The electronic device may further include a shield sheet that is interposed between the display panel and the printed circuit board, and the sensor may be interposed between the display panel and the shield sheet or between the shield sheet and the printed circuit board.

The processor may allow the display driver integrated circuit to make light emission of at least a part of the pixels when a distance from the sensed external object is greater than or equal to a specified length, and may prevent the display driver integrated circuit from making light emission of the at least a part of the pixels when the distance from the sensed external object is less than the specified length.

The display driver integrated circuit may transmit a time indicating when the timing controller turns off the driver, to the processor, and the processor may allow the sensor to turn on the light source in response to the transmission of the time.

The pixels may include a first pixel group positioned in an area corresponding to the sensor, and a second pixel group corresponding to pixels not included in the first pixel group, and the driver may include a first pixel group driver electrically connected with the first pixel group, and a second pixel group driver electrically connected with the second pixel group.

The display driver integrated circuit may allow the sensor to turn on the light source while the timing controller turns off the first driver.

According to an embodiment, a display may include an infrared light-emitting unit that emits light of an infrared band, a display panel that includes one or more pixels each including at least one light-emitting unit, and a display driver integrated circuit. Each of the one or more pixels may include one or more switches connected between the at least one light-emitting unit and a power input terminal. The display driver integrated circuit may close the switches to allow the power input terminal to apply a power to the at least one light-emitting unit during a first time when the light in the infrared band is not output through the infrared light-emitting unit, and may open switches included in at least a part of the one or more pixels during a second time when the light in the infrared band is output by using the infrared light-emitting unit.

The display driver integrated circuit may verify an active period of one or more switching circuits associated with pixels from the one or more pixels which are positioned within a specified range from the infrared light-emitting unit, when emission of the light in the infrared band is requested, and may control the infrared light-emitting unit so as to emit light within a period which does not overlap the active period of the one or more switching circuits associated with the pixels positioned within the specified range.

A light-emitting unit corresponding to switches that are opened may not emit light during the second time.

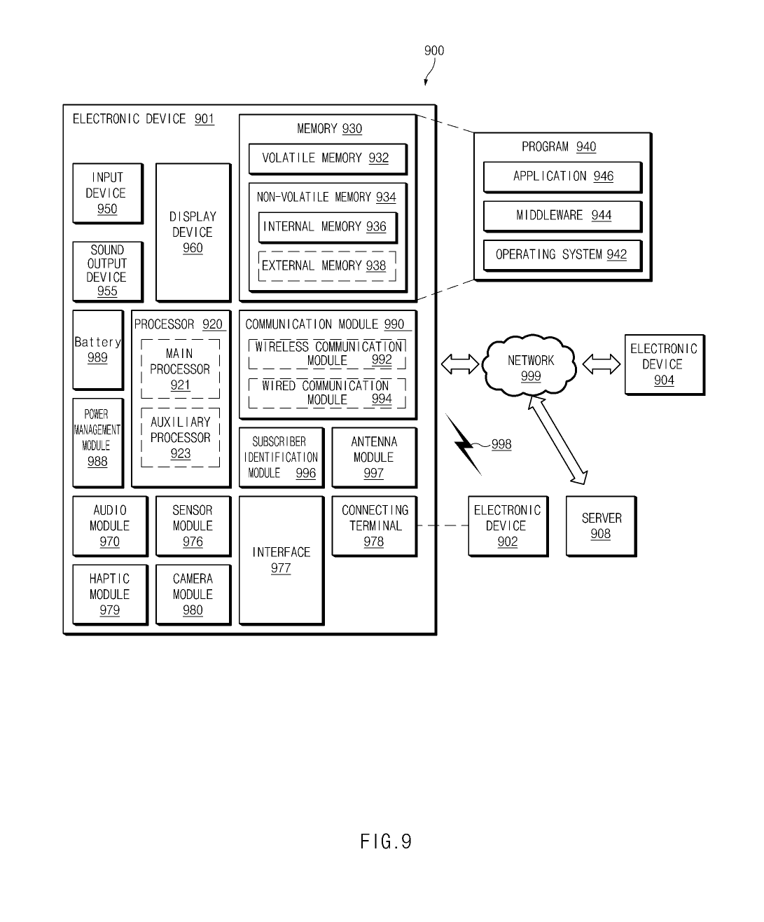

FIG. 9 is a diagram of an electronic device, which includes a display for reducing the leakage current, in a network environment, according to an embodiment.

Referring to FIG. 9, an electronic device 901 may communicate with an electronic device 902 through a first network 998 (e.g., a short-range wireless communication) or may communicate with an electronic device 904 or a server 908 through a second network 999 (e.g., a long-distance wireless communication) in a network environment 900. The electronic device 901 may communicate with the electronic device 904 through the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module 996, and an antenna module 997. At least one component (e.g., the display device 960 or the camera module 980) among components of the electronic device 901 may be omitted or other components may be added to the electronic device 901. Some components may be integrated and implemented as in the case of the sensor module 976 (e.g., a fingerprint sensor, an iris sensor, or an illuminance sensor) embedded in the display device 960 (e.g., a display).

The processor 920 may operate software (e.g., a program 940) to control at least one of other components (e.g., a hardware or software component) of the electronic device 901 connected to the processor 920 and may process and compute a variety of data. The processor 920 may load a command set or data, which is received from other components (e.g., the sensor module 976 or the communication module 990), into a volatile memory 932, may process the loaded command or data, and may store result data into a nonvolatile memory 934. The processor 920 may include a main processor 921 (e.g., a CPU or an AP) and an coprocessor 923 (e.g., a graphic processing device, an image signal processor, a sensor hub processor, or a CP), which operates independently from the main processor 921, additionally or alternatively uses less power than the main processor 921, or is specified to a designated function. The coprocessor 923 may operate separately from the main processor 921 or embedded.

The coprocessor 923 may control at least some of functions or states associated with at least one component (e.g., the display device 960, the sensor module 976, or the communication module 990) among the components of the electronic device 901 instead of the main processor 921 while the main processor 921 is in an inactive (e.g., sleep) state or together with the main processor 921 while the main processor 921 is in an active (e.g., an application execution) state. The coprocessor 923 (e.g., the image signal processor or the communication processor) may be implemented as a part of another component (e.g., the camera module 980 or the communication module 990) that is functionally related to the coprocessor 923. The memory 930 may store a variety of data used by at least one component (e.g., the processor 920 or the sensor module 976) of the electronic device 901 software and input data or output data with respect to commands associated with the software. The memory 930 may include the volatile memory 932 or the nonvolatile memory 934.

The program 940 may be stored in the memory 930 as software and may include an operating system 942, a middleware 944, or an application 946.

The input device 950 may be a device for receiving a command or data, which is used for a component (e.g., the processor 920) of the electronic device 901, from an outside (e.g., a user) of the electronic device 901 and may include a microphone, a mouse, or a keyboard.

The sound output device 955 may be a device for outputting a sound signal to the outside of the electronic device 901 and may include a speaker used for general purposes, such as multimedia play or recordings play, and a receiver used only for receiving calls. The receiver and the speaker may be either integrally or separately implemented.

The display device 960 may be a device for visually presenting information to the user and may include, for example, a display, a hologram device, or a projector and a control circuit for controlling a corresponding device. The display device 960 may include a touch circuitry or a pressure sensor for measuring an intensity of pressure on the touch.

The audio module 970 may convert a sound and an electrical signal in dual directions. The audio module 970 may obtain the sound through the input device 950 or may output the sound through an external electronic device (e.g., the electronic device 902 (e.g., a speaker or a headphone)) wired or wirelessly connected to the sound output device 955 or the electronic device 901.

The sensor module 976 may generate an electrical signal or a data value corresponding to an operating state (e.g., power or temperature) inside or an environmental state outside the electronic device 901. The sensor module 976 may include a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 977 may support a designated protocol wired or wirelessly connected to the external electronic device 902. The interface 977 may include a high-definition multimedia interface (HDMI), a universal serial bus (USB) interface, an SD card interface, or an audio interface.

A connection terminal 978 may include a connector that physically connects the electronic device 901 to the external electronic device 902 an HDMI connector, a USB connector, an SD card connector, or an audio connector (e.g., a headphone connector).

The haptic module 979 may convert an electrical signal to a mechanical stimulation (e.g., vibration or movement) or an electrical stimulation perceived by the user through tactile or kinesthetic sensations. The haptic module 979 may include a motor, a piezoelectric element, or an electric stimulator.

The camera module 980 may shoot a still image or a video image. The camera module 980 may include at least one lens, an image sensor, an image signal processor, or a flash.

The power management module 988 may be a module for managing power supplied to the electronic device 901 and may serve as at least a part of a power management integrated circuit (PMIC).

The battery 989 may be a device for supplying power to at least one component of the electronic device 901 and may include a non-rechargeable (primary) battery, a rechargeable (secondary) battery, or a fuel cell.

The communication module 990 may establish a wired or wireless communication channel between the electronic device 901 and the external electronic device (e.g., the electronic device 902, the electronic device 904, or the server 908) and support communication execution through the established communication channel. The communication module 990 may include at least one communication processor operating independently from the processor 920 (e.g., the AP) and supporting the wired communication or the wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication module) and may communicate with the external electronic device using a corresponding communication module among them through the first network 998 (e.g., the short-range communication network such as a Bluetooth, a WiFi direct, or an infrared data association (IrDA)) or the second network 999 (e.g., the long-distance wireless communication network such as a cellular network, an internet, or a computer network (e.g., LAN or WAN)). The above-mentioned various communication modules 990 may be implemented into one chip or into separate chips, respectively.

The wireless communication module 992 may identify and authenticate the electronic device 901 using user information stored in the subscriber identification module 996 in the communication network.

The antenna module 997 may include one or more antennas to transmit or receive the signal or power to or from an external source. The communication module 990 (e.g., the wireless communication module 992) may transmit or receive the signal to or from the external electronic device through the antenna suitable for the communication method.

Some components among the components may be connected to each other through a communication method (e.g., a bus, a general purpose input/output (GPIO), a serial peripheral interface (SPI), or a mobile industry processor interface (MIPI)) used between peripheral devices to exchange signals (e.g., a command or data) with each other.

The command or data may be transmitted or received between the electronic device 901 and the external electronic device 904 through the server 908 connected to the second network 999. Each of the electronic devices 902 and 904 may be the same or different types as or from the electronic device 901. All or some of the operations performed by the electronic device 901 may be performed by another electronic device or a plurality of external electronic devices. When the electronic device 901 performs some functions or services automatically or by request, the electronic device 901 may request the external electronic device to perform at least some of the functions related to the functions or services, in addition to or instead of performing the functions or services by itself. The external electronic device receiving the request may carry out the requested function or the additional function and transmit the result to the electronic device 901. The electronic device 901 may provide the requested functions or services based on the received result as is or after additionally processing the received result. To this end a cloud computing, distributed computing, or client-server computing technology may be used.

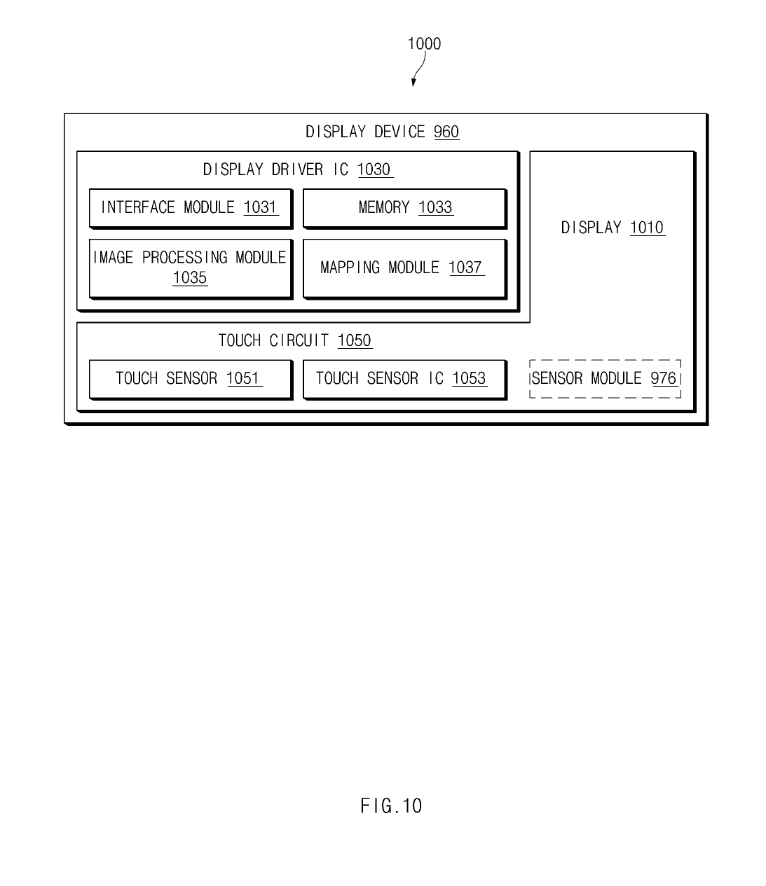

FIG. 10 is a diagram of a display device for reducing a leakage current, according to an embodiment.

Referring to FIG. 10, the display device 960 may include a display 1010, and a display driver IC (DDI) 1030 for controlling the display 1010. The DDI 1030 may include an interface module 1031, a memory 1033 (e.g., a buffer memory), an image processing module 1035, or a mapping module 1037. The DDI 1030 may receive image information including image data or an image control signal corresponding to a command for controlling the image data, for example, from the main processor 921 (e.g., an AP) or the coprocessor 923 operated independently of a function of the main processor 921 through the interface module 1031. The DDI 1030 may communicate with a touch circuit 1050 or the sensor module 976 through the interface module 1031. Also, the DDI 1030 may store at least a portion of the received image information in the memory 1033, for example, by the frame. The image processing module 1035 may perform pre-processing or post-processing (e.g., resolution, brightness, or size adjustment) on at least a portion of the image data based at least on a characteristic of the image data or a characteristic of the display 1010. The mapping module 1037 may convert the image data pre-processed or post-processed through the image processing module 1035 to a voltage value or a current value for driving pixels in the display 1010, based at least partly on attributes (e.g., the arrangement (an RGB stripe or pentile) of the pixels or the size of each of sub-pixels) of the pixels. When at least a part of the pixels in the display 1010 is driven based on the voltage value or the current value, visual information (e.g., a text, an image, or an icon) corresponding to the image data may be displayed in the display 1010.

The display device 960 may further include the touch circuit 1050. The touch circuit 1050 may include a touch sensor 1051 and a touch sensor IC 1053 for controlling the touch sensor 1051. The touch sensor IC 1053 may control the touch sensor 1051 to sense a touch input or a hovering input associated with a specific position of the display 1010 by measuring a change of a signal (e.g., a voltage, the amount of light, a resistance value, or the amount of charges) associated with the specific position, and may provide information (e.g., a location, the area, or a time) about the sensed touch input or hovering input to the processor 920. At least a part (e.g., the touch sensor IC 1053) of the touch circuit 1050 may be included as a part of the display driver IC 1053 or the display 1010, or as a part of any other component (e.g., the coprocessor 923) positioned on the outside of the display device 960.

The display device 960 may further include at least one sensor (e.g., a fingerprint sensor, an iris sensor, a pressure sensor, or an illuminance sensor) in the sensor module 976, or a control circuit associated with the at least one sensor. The at least one sensor or the control circuit associated with the at least one sensor may be embedded in a part (e.g., the display 1010 or the DDI 1030) of the display device 960 or in a part of the touch circuit 1050. When the sensor module 976 embedded in the display device 960 includes a biometric sensor (e.g., a fingerprint sensor), the biometric sensor may obtain biometric information (e.g., a fingerprint image) associated with a touch input through a partial area of the display 1010. When the sensor module 976 embedded in the display device 960 includes a pressure sensor, the pressure sensor may obtain pressure information associated with a touch input through a partial area or the whole area of the display 1010. The touch sensor 1051 or the sensor module 976 may be positioned between pixels of a pixel layer of the display 1010 or above or below the pixel layer.

Various embodiments of the present disclosure may be implemented by software including an instruction stored in a machine-readable storage media readable by a machine (e.g., a computer). The machine may be a device that calls the instruction from the machine-readable storage media and operates depending on the called instruction and may include the electronic device. When the instruction is executed by the processor, the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the present disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above sub-components may be omitted, or additional other sub-components may be further included. Alternatively or additionally, some components may be integrated in one component and may perform the same or similar functions performed by each corresponding components prior to the integration. Operations performed by a module, a programming, or other components according to various embodiments of the present disclosure may be executed sequentially, in parallel, repeatedly, or in a heuristic method. Also, at least some operations may be executed in different sequences, omitted, or other operations may be added.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

What is claimed is:

1. An electronic device, comprising:
a display panel including a plurality of pixels;
a light source positioned around at least a part of the plurality of pixels;
a display driver integrated circuit, including:
a driver configured to control whether the pixels emit light, and
a timing controller configured to control an on/off operation of the driver;
a sensor electrically connected with the light source and the display driver integrated circuit, and configured to sense an external object by using light of a specified wavelength band emitted from the light source; and
a processor electrically connected with the display driver integrated circuit and the sensor,
wherein the processor is configured to:
receive a time indicating when the timing controller turns off the driver from the display driver integrated circuit; and
allow the light source to emit the light of the specified wavelength band based at least on the received time.

2. The electronic device of claim 1, wherein the processor is further configured to allow the light source to emit the light of the specified wavelength band during at least a portion of a period where the timing controller turns off the driver.

3. The electronic device of claim 1, wherein the processor is further configured to:
allow the timing controller to turn on the driver during a first time; and
allow the light source to emit the light of the specified wavelength band during a second time at least partially different from the first time.

4. The electronic device of claim 1, further comprising:
a shield sheet positioned under the display panel, and
an opening being defined in a specified area of the shield sheet,
wherein the light source is positioned in an area corresponding to the opening.

5. The electronic device of claim 1, wherein the plurality of pixels include a first pixel group positioned in an area around the light source and a second pixel group corresponding to pixels not included in the first pixel group, and
wherein the driver includes a first pixel group driver electrically connected with the first pixel group and a second pixel group driver electrically connected with the second pixel group.

6. The electronic device of claim 5, wherein the processor receives a time indicating when the timing controller turns off the first pixel group driver, and allows the light source to emit the light of the specified wavelength band based at least on the received time indicating when the timing controller turns off the first pixel group driver.

7. The electronic device of claim 1, wherein the driver includes an emission driver, and
wherein the driver controls whether the pixels emit light by controlling an on/off operation of a transistor included in each of the pixels.

8. The electronic device of claim 1, wherein the sensor obtains biometric information including fingerprint information of a finger of a user or iris information of the user by using the light of the specified wavelength band.

9. The electronic device of claim 1, wherein the processor is further configured to:
allow the display driver integrated circuit to turn on at least a part of the pixels when a distance from the sensed external object is greater than or equal to a specified length; and
allow the display driver integrated circuit to turn off the at least a part of the pixels when the distance from the sensed external object is less than the specified length.

10. The electronic device of claim 1, wherein the processor is further configured to allow the light source to emit light in an infrared band.

11. An electronic device, comprising:
a housing;
a display panel including a plurality of pixels,
wherein at least a portion of the display panel is exposed through a first surface of the housing;
a sensor positioned around at least a part of the plurality of pixels and including a light source configured to emit light of a specified wavelength band; and
a display driver integrated circuit electrically connected with the sensor and including:
a driver configured to control whether the pixels emit light, and
a timing controller configured to control an on/off operation of the driver,
wherein the sensor turns the light source on or off to sense an external object, and
wherein the display driver integrated circuit allows the sensor to turn on the light source while the timing controller turns off the driver.

12. The electronic device of claim 11, further comprising:
a printed circuit board interposed between the display panel and a second surface of the housing; and
a processor mounted on the printed circuit board and electrically connected with the sensor and the display driver integrated circuit.

13. The electronic device of claim 12, further comprising:
a shield sheet interposed between the display panel and the printed circuit board,
wherein the sensor is interposed between the display panel and the shield sheet or between the shield sheet and the printed circuit board.

14. The electronic device of claim 12, wherein the processor is further configured to:
allow the display driver integrated circuit to make light emission of at least a part of the pixels when a distance from the sensed external object is greater than or equal to a specified length; and
prevent the display driver integrated circuit from making light emission of the at least a part of the pixels when the distance from the sensed external object is less than the specified length.

15. The electronic device of claim 12, wherein the display driver integrated circuit transmits a time indicating when the timing controller turns off the driver, to the processor, and
wherein the processor allows the sensor to turn on the light source in response to the transmission of the time.

16. The electronic device of claim 11, wherein the pixels include a first pixel group positioned in an area corresponding to the sensor, and a second pixel group corresponding to pixels not included in the first pixel group, and
wherein the driver includes a first pixel group driver electrically connected with the first pixel group and a second pixel group driver electrically connected with the second pixel group.

17. The electronic device of claim 16, wherein the display driver integrated circuit allows the sensor to turn on the light source while the timing controller turns off the first pixel group driver.

18. A display, comprising:
an infrared light-emitting unit configured to emit light of an infrared band;
a display panel including one or more pixels each including at least one light-emitting unit; and
a display driver integrated circuit,
wherein each of the one or more pixels includes one or more switches connected between the at least one light-emitting unit and a power input terminal, and
wherein the display driver integrated circuit is configured to:
close the one or more switches to allow the power input terminal to apply a power to the at least one light-emitting unit during a first time when the light in the infrared band is not output through the infrared light-emitting unit; and
open switches of the one or more switches that are included in at least a part of the one or more pixels during a second time when the light in the infrared band is output by using the infrared light-emitting unit.

19. The display of claim 18, wherein the display driver integrated circuit is further configured to:
verify an active period of one or more switching circuits that are associated with pixels from the one or more pixels and which are positioned within a specified range from the infrared light-emitting unit, when emission of the light in the infrared band is requested; and
control the infrared light-emitting unit so as to emit light within a period which does not overlap the active period of the one or more switching circuits associated with the pixels positioned within the specified range.

20. The display of claim 18, wherein a light-emitting unit corresponding to switches that are open does not emit light during the second time.
